(19) United States
(12) Patent Application Publication
(10) Pub. No.: US 2007/0275274 A1
(43) Pub. Date: Nov. 29, 2007

(54) METHOD OF CALCULATING FUEL CONCENTRATION IN DIRECT METHANOL FUEL CELL

(76) Inventors: Feng-Yi Deng, Taipei (TW); Hsin-Chung Lien, Taipei (TW); Wen-Sen Hsieh, Taipei (TW); Yu-Jen Chiu, Taipei (TW)

Correspondence Address: G. LINK CO ., LTD, 3550 BELL ROAD, MINOOKA, IL, 60447, US

(21) Appl. No.: 11/419,961

(22) Filed: May 23, 2006

(51) Int. Cl. H01M 8/04

(52) U.S. Cl. 429/13; 429/23; 429/24; 429/22

(57) ABSTRACT

A method of calculating a fuel concentration in a direct methanol fuel cell is disclosed, and comprises the following steps. A direct methanol fuel cell is provided. One or more fuels with different known concentrations are separately provided for the direct methanol fuel cell such that the direct methanol fuel cell performs electrochemical reactions and generates power on the conditions of different known concentrations of fuels. A plurality of physical parameters produced when the direct methanol fuel cell is operated with fuels having known concentrations are respectively measured and recorded, and three of the physical parameters are selected to construct a corresponding three-dimensional measuring space. An interpolation means is generated based on the three-dimensional measuring space. At least three instant physical parameters are measured when a fuel with an unknown concentration is provided for the direct methanol fuel cell to react and generate power, and the interpolation means is used to calculate a current fuel concentration in the direct methanol fuel cell.

### FIELD OF THE INVENTION

The present invention relates to a concentration meter, and more particularly, to a method of calculating fuel concentration, which is applied to a direct methanol fuel cell.

### BACKGROUND OF THE INVENTION

Conventionally, the fuel concentration of the direct methanol fuel cell (DMFC) is measured by the concentration sensor. However, the concentration sensor needs to be scaled down for a more compact DMFC. Otherwise, it is not allowed to dispose the concentration sensor in a miniaturized DMFC, even though it can detect the concentration of fuels.

In view of the aforesaid disadvantage, a method to calculate fuel concentration in a DMFC is provided. The method can serve as a virtual fuel concentration sensor for measuring the concentration of fuels.

### SUMMARY OF THE INVENTION

It is a primary object of the invention to provide a method of calculating fuel concentration without using a real concentration meter. The method can measure the then fuel concentration in the direct methanol fuel cell (DMFC) as the DMFC performs electrochemical reactions.

It is a secondary object of the invention to provide a method of calculating fuel concentration substituting for a real concentration meter. The method can then measure the fuel concentration in the DMFC as the DMFC performs electrochemical reactions.

In accordance with the aforesaid objects of the invention, a method of calculating the fuel concentration in a DMFC is provided, which described the following steps. A DMFC is provided. One or more fuels with different known concentrations are separately provided for the DMFC, such that the DMFC performs electrochemical reactions and generates power on the conditions of different known concentrations of fuels. A plurality of physical parameters produced when the DMFC is operated with fuels having known concentrations are respectively measured and recorded, and three of the physical parameters are selected to construct a corresponding three-dimensional measuring space. An interpolation means is generated based on the three-dimensional measuring space for calculating an unknown fuel concentration in the DMFC. At least three instant physical parameters are measured when a fuel with an unknown concentration is provided for the DMFC to react and generate power, and the interpolation means is used to calculate a current fuel concentration in the DMFC.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 is a flow chart for calculating fuel concentration in a DMFC system according to an embodiment of the invention;

FIG. 2 illustrates the structural diagram of a DMFC system, which matches up with the method in accordance with an embodiment of the invention;

FIG. 3 is a graph of equi-concentration curves computed by a 3-D measuring space with various known fuel concentrations according to an embodiment of the invention; and

FIG. 4 is a flow chart for constructing an interpolation means according to an embodiment of the invention.

### DETAILED DESCRIPTION OF THE INVENTION

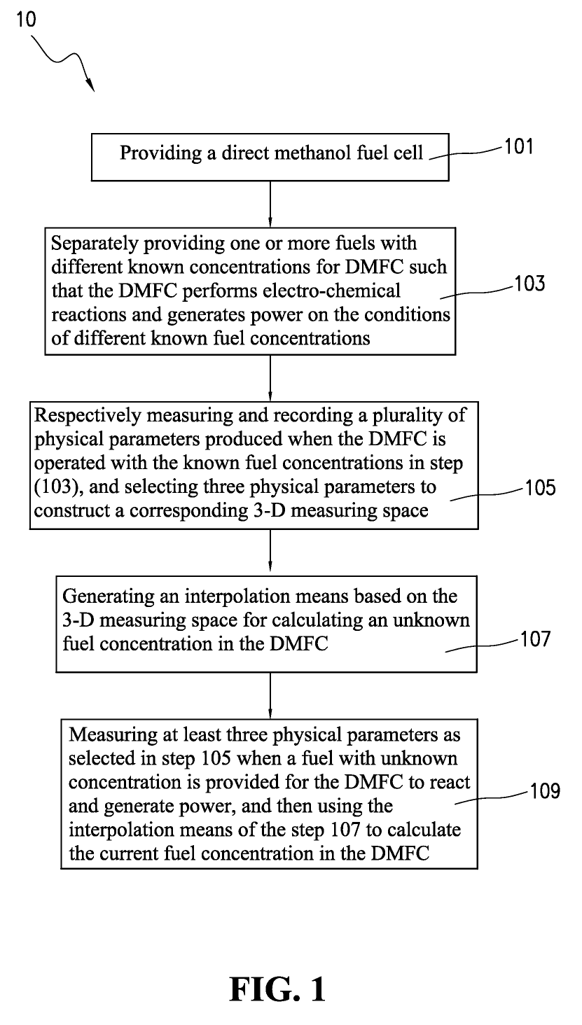

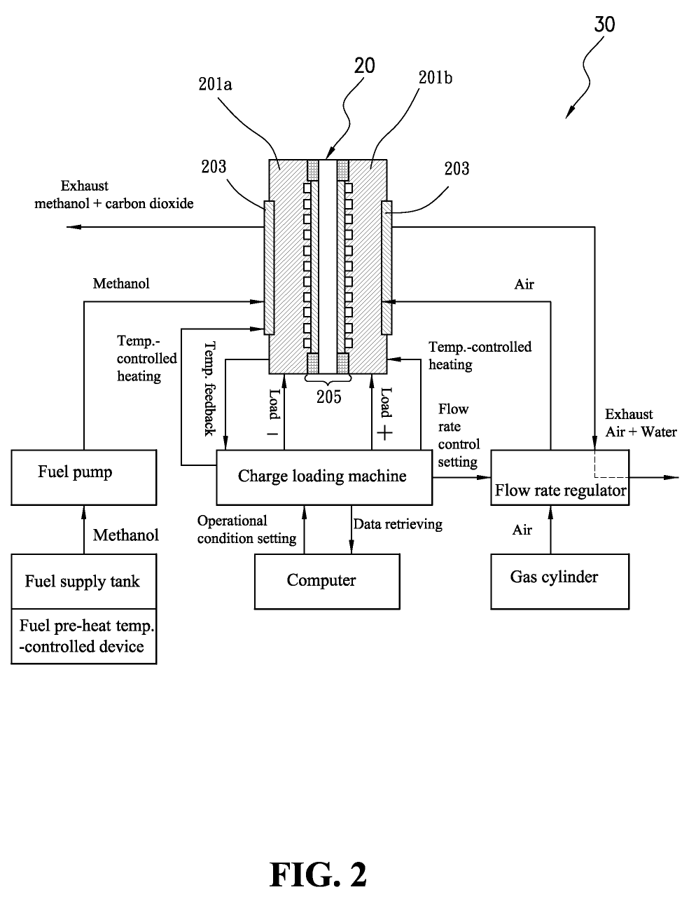

FIG. 1 is a flow chart for calculating fuel concentration in a direct methanol fuel cell (DMFC) system according to an embodiment of the invention. Method 10 is provided for calculating the present concentration of fuels in a DMFC 20 has no need of a real concentration meter. The method 10 for calculating fuel concentration includes steps 101-109, which are respectively described hereinafter. A DMFC 20 is provided in step 101. In step 103, one or more fuels with different known concentration are separately provided for the DMFC 20, and then the DMFC 20 performs electrochemical reactions and generates power in various conditions due to different known concentrations of fuels. In steps 101 and 103, fuels with different known concentrations are separately provided for the DMFC 20 so that the DMFC 20 has several known concentrations with which to perform electrochemical reactions. In order to measure required physical properties conveniently, DMFC system 30 that matches up the method 10 is provided with reference to FIG. 2. In FIG. 2, the component 201a is an anode current collection plate, the component 201b is a cathode current collection plate, the component 203 is a temperature-controlled heating plate, and the component 205 is a membrane electrode assembly (MEA).

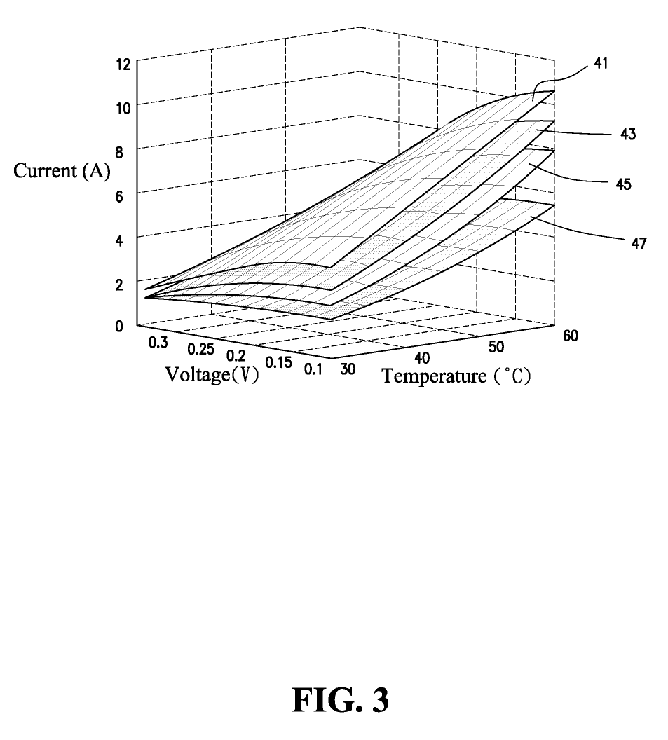

Step 105 is performed to measure and record the physical properties or parameters produced when the DMFC 20 is operated with fuels of different known concentrations in step 103, and to select three kinds of physical properties for constructing a corresponding three-dimensional (3-D) measuring space. On the condition of known fuel concentrations in step 105, one preferred embodiment of the invention selects parameters of temperature, voltage and current to create a 3-D measuring space corresponding to the DMFC 20. As each fuel with a known concentration is supplied for the DMFC system 30 and the DMFC 20 performs electrochemical reactions accordingly, the varying parameters of temperature, voltage and current are measured and recorded. These parameters are also transferred to the computer shown in FIG. 2. Next, the computer processes the received information and generates a 3-D measuring space corresponding to the known fuel concentration and the parameters of temperature, voltage and current. FIG. 3 shows a graph of equi-concentration curves computed by a 3-D measuring space with various known fuel concentrations according to an embodiment of the invention. Referring to FIG. 3, equi-concentration curves 41, 43, 45, 47 respectively result from different known concentrations C₁, C₂, C₃, C₄, and three coordinate axes thereof individually represent voltage, temperature and current.

The known concentration of fuels in step 105 may be from 3v % to 8v %. The measured and recorded temperature preferably ranges within 10° C. and 80° C., while the voltage preferably ranges between 0V and 0.5V.

Step 107 is provided to generate an interpolation means based on the 3-D measuring space, which is used to calculate an unknown fuel concentration in the DMFC 20. In step 107, each equi-concentration curve of the 3-D measuring space has been plotted, and hence the unknown concentration of fuels can be figured out by using the interpolation means. Step 109 is performed to measure at least three parameters as same as those selected in step 105 when a fuel with an unknown concentration is provided for the DMFC 20 to react and generate power, and then to calculate the current fuel concentration in the DMFC 20 using the constructed interpolation means in step 107.

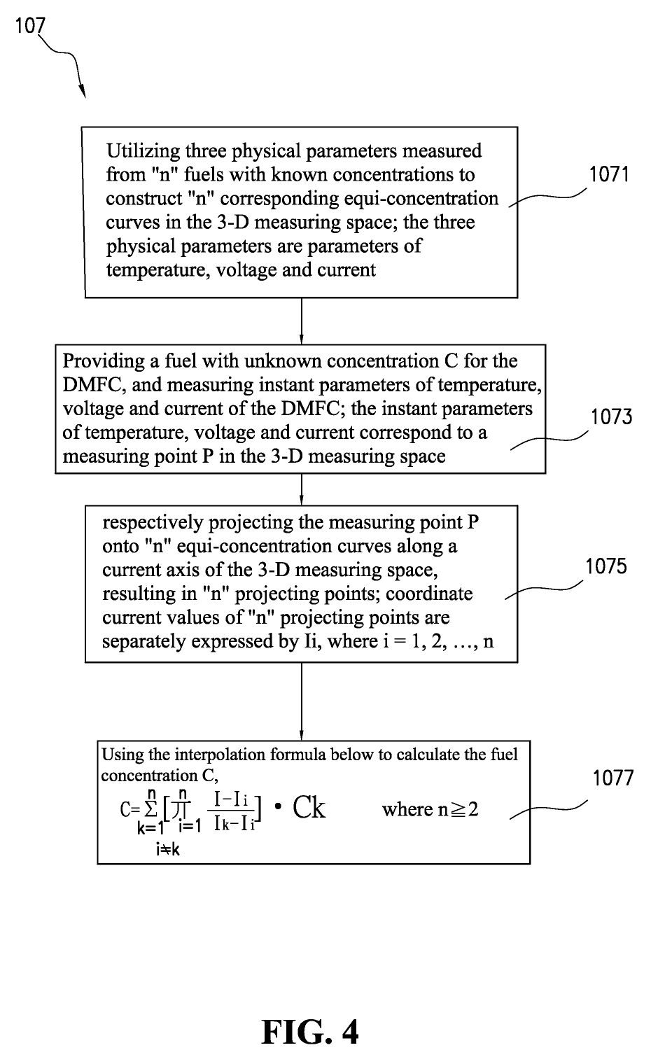

FIG. 4 is a flow chart of constructing the interpolation means according to an embodiment of the invention. Step 1071 utilizes parameters of temperature, voltage and current resulted and measured from “n” kinds of fuels with known concentrations C₁, C₂, . . . , Cₖ, where k=1, 2, . . . , n, to construct “n” items of corresponding equi-concentration curves in the 3-D measuring space. For example, the equi-concentration curve 41 shown in FIG. 3 is generated as k equals 1 in step 1071. Step 1073 is used to provide a fuel with unknown concentration C for the DMFC 20, and to measure the instant temperature, voltage and current of the DMFC 20 during its electrochemical reactions. Such measured parameters of temperature, voltage and current correspond to a coordinate point in the 3-D measuring space. The coordinate point is regarded as a measuring point P for estimating the unknown concentration.

In step 1075, the measuring point P is projected onto the respective “n” items of equi-concentration curves along the current axis of the 3-D measuring space, resulting in “n” projecting points; wherein coordinate values of current for these “n” projecting points are expressed by Iᵢ, and i=1, 2, . . . , n. Step 1077 uses the following interpolation formula to calculate the fuel concentration C:

$$C = {\sum }_{k = 1}^{n} ( {\prod }_{{i = 1}_{i \neq k}}^{n} \frac{I - {I}_{i}}{{I}_{k} - {I}_{i}} ) \cdot {C}_{k}$$

where n≧2.

After performing steps 101-105, the method 10 can determine the equi-concentration curves regarding to the DMFC 20. Then, step 107 and step 109 may be implemented program codes, i.e. programming the equi-concentration curves and the above interpolation formula in instruction codes being executed by a processor (not shown) of the DMFC 20.

The aforementioned method 10 is regarded as a virtual concentration sensor because an unknown fuel concentration can be obtained by using the equi-concentration curves in the 3-D measuring space and by calculating an insertion value. Accordingly, the application is novel.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. A method of calculating a fuel concentration in a direct methanol fuel cell, the method comprising steps of:
(A) providing a direct methanol fuel cell;
(B) separately providing one or more fuels with different known concentrations for the direct methanol fuel cell such that the direct methanol fuel cell performs electrochemical reactions and generates power on various conditions of different known concentrations of fuels;
(C) respectively measuring and recording a plurality of physical parameters produced when the direct methanol fuel cell is operated with the fuels of the known concentrations in step (B), and selecting three of the physical parameters to construct a corresponding three-dimensional measuring space;
(D) generating an interpolation means based on the three-dimensional measuring space for calculating an unknown fuel concentration in the direct methanol fuel cell; and
(E) measuring at least three physical parameters as same as those selected in step (C) when a fuel with an unknown concentration is provided for the direct methanol fuel cell to react and generate power, and then using step (D) of the constructed interpolation means to calculate a current fuel concentration in the direct methanol fuel cell.

2. The method of claim 1, wherein each known concentration of fuels in step (B) ranges between 3v % and 8v %.

3. The method of claim 1, wherein the parameters selected in step (C) comprise a parameter of temperature, a parameter of voltage and a parameter of current.

4. The method of claim 3, wherein the parameter of temperature recorded in step (C) ranges between 10° C. and 80° C.

5. The method of claim 3, wherein the parameter of voltage recorded in step (C) ranges between 0 Volt and 0.5 Volts.

6. The method of claim 1, wherein said interpolation means is implemented as programming codes.

7. The method of claim 1, wherein the direct methanol fuel cell is a bipolar direct methanol fuel cell.

8. The method of claim 1, wherein the direct methanol fuel cell is a direct methanol fuel cell fabricated by a printed circuit board process.

9. The method of claim 1, wherein step (D) of generating said interpolation means comprises:
(d1) utilizing three physical parameters resulted and measured from “n” kinds of fuels with known concentrations C₁, C₂, . . . , Cₖ, where k=1, 2, . . . , n, to construct “n” items of corresponding equi-concentration curves in the three-dimensional measuring space, and the three physical parameters are a parameter of temperature, a parameter of voltage and a parameter of current.
(d2) providing a fuel with an unknown concentration C for the direct methanol fuel cell, and measuring instant parameters of temperature, voltage and current of the direct methanol fuel cell, wherein the instant parameters of temperature, voltage and current correspond to a measuring point P in the three-dimensional measuring space;
(d3) respectively projecting the measuring point P onto the “n” items of equi-concentration curves along a current axis of the three-dimensional measuring space, resulting in “n” projecting points, wherein coordinate current values of the “n” projecting points are separately expressed by Iᵢ, where i=1, 2, . . . , n; and
(d4) using a formula below to calculate the fuel concentration C,
$$C = {\sum }_{k = 1}^{n} ( {\prod }_{{i = 1}_{i \neq k}}^{n} \frac{I - {I}_{i}}{{I}_{k} - {I}_{i}} ) \cdot {C}_{k}$$
wherein n≧2
